(19) United States
(12) Patent Application Publication
(10) Pub. No.: US 2013/0250867 A1
(43) Pub. Date: Sep. 26, 2013

(54) APPARATUS AND METHOD FOR ENABLING AN ENHANCED ACCESS CHANNEL ACCORDING TO CONTROL INFORMATION ON A PAGING CHANNEL

(71) Applicants: Ravindra Manohar Patwardhan, San Diego, CA (US); Vikram Gupta, San Diego, CA (US); Jun Ma, San Diego, CA (US); Rashid Ahmed Akbar Attar, San Diego, CA (US)

(72) Inventors: Ravindra Manohar Patwardhan, San Diego, CA (US); Vikram Gupta, San Diego, CA (US); Jun Ma, San Diego, CA (US); Rashid Ahmed Akbar Attar, San Diego, CA (US)

(73) Assignee: Qualcomm Incorporated, San Diego, CA (US)

(21) Appl. No.: 13/614,871

(22) Filed: Sep. 13, 2012

Related U.S. Application Data
(60) Provisional application No. 61/554,886, filed on Nov. 2, 2011.

(51) Int. Cl. H04W 68/02

(52) U.S. Cl. CPC H04W 68/02
USPC 370/329

(57) ABSTRACT

Apparatus and methods are provided for enabling communication on an enhanced access channel (EACH) without necessitating the additional features or channels usually implemented along with this capability. To this end, control information corresponding to the EACH transmission may be provided to an access terminal on a paging channel (PCH). For example, a base station may broadcast a general access parameters message (GAPM) to enable the access terminal to configure EACH transmissions. Further, the PCH may carry acknowledgment messages to inform the access terminal of the status of the EACH transmissions. Other aspects, embodiments, and features are also claimed and described.

### CROSS-REFERENCE TO RELATED APPLICATION & PRIORITY CLAIM

This application claims priority to and the benefit of provisional patent application no. 61/554,886, titled “Devices, Systems, and Methods Enabling Enhanced Access Channel in CDMA2000 1x with Paging Channel” and filed in the United States Patent and Trademark Office on Nov. 2, 2011, the entire content of which is incorporated herein by reference as if fully set forth below and for all applicable purposes.

### TECHNICAL FIELD

Aspects of the present disclosure relate generally to wireless communication systems, and more particularly, to methods and devices for enabling reverse link transmissions utilizing an enhanced access channel (EACH) in association with control information provided on a paging channel (PCH).

### BACKGROUND

Wireless communications systems are widely deployed to provide various types of communication content such as voice, video, packet data, messaging, broadcast, and so on. These systems may be accessed by various types of devices adapted to facilitate wireless communications, where multiple devices share the available system resources (e.g., time, frequency, and power). Examples of such wireless communications systems include code-division multiple access (CDMA) systems, time-division multiple access (TDMA) systems, frequency-division multiple access (FDMA) systems and orthogonal frequency-division multiple access (OFDMA) systems.

Some such systems configured according to 3GPP2 cdma2000 1x specifications enable certain communication on the reverse link (uplink) transmitted from the access terminal to the base station utilizing the reverse access channel (RACH). In Rev A and later standards (e.g., Rev A-Rev E), an Enhanced Access Channel (EACH) may be provided in addition to or in the place of the RACH. In such systems, the EACH may be used to transmit, for example, short messages including signaling, MAC layer messages, paging responses, call origination messages, and data messages of a certain size. Of course, in accordance with an aspect of the present disclosure, any suitable signaling and/or data information may be carried on an EACH.

To utilize the EACH, a compatible system conventionally transmits control information (i.e., signaling) associated with the use of the EACH from a base station to the access terminal utilizing channels such as the primary broadcast control channel (P-BCCH) and/or the forward common control channel (F-CCCH). For example, an Enhanced Access Parameters Message (EAPM) may be transmitted to the access terminal on the P-BCCH, including information such as an EAPM sequence number, persistence related parameters, access control parameters, power control information, interference correction information, etc., for use by the access terminal in preparing and transmitting EACH messages.

Further, after receiving EACH transmissions from the access terminal, the conventional base station generally acknowledges the EACH transmissions by transmitting an acknowledgment (e.g., a BS-ACK order) on a forward common control channel (F-CCCH).

As the demand for mobile broadband access continues to increase, research and development continue to advance the UMTS technologies not only to meet the growing demand for mobile broadband access, but to advance and enhance the user experience with mobile communications.

### BRIEF SUMMARY OF SOME EMBODIMENTS

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides a method of wireless communication operable at an access terminal. Here, the method includes receiving, on a paging channel, control signaling associated with the transmission of an enhanced access channel (EACH) and transmitting the EACH in accordance with the control signaling received on the paging channel.

Another aspect of the disclosure provides a method of wireless communication operable at an access terminal. Here, the method includes receiving, on a forward link channel, control signaling associated with the transmission of an enhanced access channel (EACH) and transmitting the EACH in accordance with the control signaling received on the forward link channel, wherein the access terminal is configured according to a 3GPP2 1x rev0 specification.

Another aspect of the disclosure provides an access terminal configured for wireless communication, including means for receiving, on a paging channel, control signaling associated with the transmission of an enhanced access channel (EACH), and means for transmitting the EACH in accordance with the control signaling received on the paging channel.

Another aspect of the disclosure provides an access terminal configured for wireless communication, including means for receiving, on a forward link channel, control signaling associated with the transmission of an enhanced access channel (EACH), and means for transmitting the EACH in accordance with the control signaling received on the forward link channel, wherein the access terminal is configured according to a 3GPP2 1x rev0 specification.

Another aspect of the disclosure provides an access terminal configured for wireless communication, including a processing circuit, a communication interface coupled to the processing circuit, and a memory coupled to the processing circuit. Here, the processing circuit is configured to receive, on a paging channel, control signaling associated with the transmission of an enhanced access channel (EACH), and to transmit the EACH in accordance with the control signaling received on the paging channel.

Another aspect of the disclosure provides an access terminal configured for wireless communication, including a processing circuit, a communication interface coupled to the processing circuit, and a memory coupled to the processing circuit. Here, the processing circuit is configured to receive, on a forward link channel, control signaling associated with the transmission of an enhanced access channel (EACH); and to transmit the EACH in accordance with the control signaling received on the forward link channel, wherein the access terminal is configured according to a 3GPP2 1x rev0 specification.

Another aspect of the disclosure provides a computer program product including a computer-readable storage medium operable at an access terminal, having instructions for causing a computer to receive, on a paging channel, control signaling associated with the transmission of an enhanced access channel (EACH) and instructions for causing a computer to transmit the EACH in accordance with the control signaling received on the paging channel.

Another aspect of the disclosure provides a computer program product including a computer-readable storage medium operable at an access terminal, having instructions for causing a computer to receive, on a forward link channel, control signaling associated with the transmission of an enhanced access channel (EACH) and instructions for causing a computer to transmit the EACH in accordance with the control signaling received on the forward link channel, wherein the access terminal is configured according to a 3GPP2 1x rev0 specification.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a block diagram illustrating an example of a hardware implementation for an apparatus employing a processing system.

FIG. 2 is a conceptual diagram illustrating an example of an access network.

FIG. 3 is a block diagram conceptually illustrating an example of an access terminal according to one example.

FIG. 4 is a block diagram conceptually illustrating an example of a base station according to one example.

FIG. 5 is a conceptual diagram illustrating an example of a radio protocol architecture for an air interface according to one example.

FIG. 6 is a flow chart illustrating a process of wireless communication utilizing a base station to enable transmission over the EACH according to one example.

FIG. 7 is a flow chart illustrating a process of wireless communication utilizing an access terminal to transmit over the EACH according to one example.

FIG. 8 is a flow chart illustrating a process of wireless communication utilizing an access terminal for managing and supporting transmission on the EACH.

### DETAILED DESCRIPTION

In the following description, specific details are given to provide a thorough understanding of the described implementations. However, it will be understood by one of ordinary skill in the art that at least some of the aspects described herein may be practiced without these specific details. For example, circuits may be shown in block diagrams in order not to obscure the implementations in unnecessary detail. In other instances, well-known circuits, structures and techniques may be shown in detail in order not to obscure the implementations.

In the following description, certain terminology is used to describe certain features of one or more implementations. The terms “access terminal” and “programming” as used herein are meant to be interpreted broadly. For example, an “access terminal” refers generally to one or more devices that communicate with one or more other devices through wireless signals. Such access terminals may also be referred to by those skilled in the art as a user equipment (UE), a mobile station (MS), a subscriber station, a mobile unit, a subscriber unit, a wireless unit, a remote unit, a mobile device, a wireless device, a wireless communications device, a remote device, a mobile subscriber station, a mobile terminal, a wireless terminal, a remote terminal, a handset, a terminal, a user agent, a mobile client, a client, or some other suitable terminology. Access terminals may include mobile terminals and/or at least substantially fixed terminals. Examples of access terminals include mobile phones, pagers, wireless modems, personal digital assistants, personal information managers (PIMs), personal media players, palmtop computers, laptop computers, tablet computers, televisions, appliances, e-readers, digital video recorders (DVRs), machine-to-machine (M2M) devices, and/or other communication/computing devices which communicate, at least partially, through a wireless or cellular network.

Furthermore, the term “programming” shall be construed broadly to include without limitation instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The Enhanced Access Channel (EACH) is an uplink (reverse link) channel that generally provides increased capacity and power efficiency compared to the conventionally available reverse link access channel, and thus, is more suitable for machine-to-machine (M2M) applications. However, the EACH is only supported in Rev A-E of cdma2000 1x standards, while most deployed 1x systems only support Rev 0. To introduce EACH in a Rev 0-compliant network, or in a Rev A-E network that lacks the EACH capability, a relatively large number of additional features and control channels in addition to those corresponding to the use of the EACH generally must be enabled. This is costly and inefficient.

Therefore, various aspects of the present disclosure address this and other issues to benefit M2M communications, as well as communications in other network types. For example, according to some aspects of the disclosure, a pairing of the EACH with control information carried on the downlink (forward link) on a paging channel (PCH) can enable access terminals in a wireless network to transmit information on the EACH without requiring the other overhead channels of cdma2000 1x Rev. A or later that are otherwise required to enable the EACH.

Aspects of the present disclosure may be incorporated into various components of a communication system. For example, some examples can be implemented in network-based components (e.g., base station, network control, or communication devices), access terminal components (e.g., mobile devices), or a combination thereof.

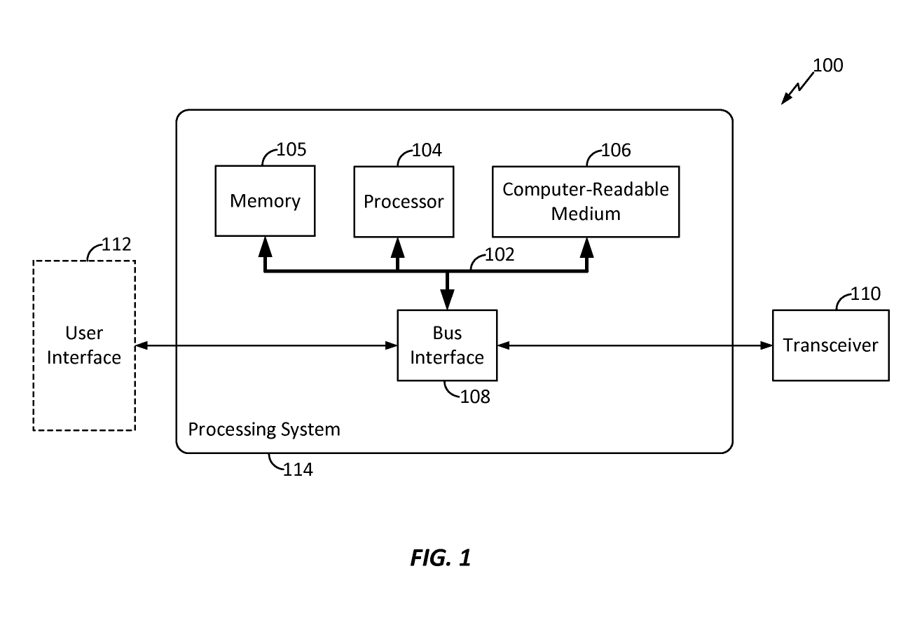

FIG. 1 is a conceptual diagram illustrating an example of a hardware implementation for an apparatus 100 employing a processing system 114. In accordance with various aspects of the disclosure, an element, or any portion of an element, or any combination of elements may be implemented with a processing system 114 that includes one or more processors 104. Examples of processors 104 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors (represented generally by the processor 104), a memory 105, and computer-readable media (represented generally by the computer-readable medium 106). The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software.

One or more processors 104 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 106. The computer-readable medium 106 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium 106 may reside in the processing system 114, external to the processing system 114, or distributed across multiple entities including the processing system 114. The computer-readable medium 106 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The various concepts presented throughout this disclosure may be implemented across a broad variety of telecommunication systems, network architectures, and communication standards. Although the discussions herein may present examples of CDMA and 3rd Generation Partnership Project 2 (3GPP2) 1x protocols and systems, those of ordinary skill in the art will recognize that one or more aspects of the present disclosure may be employed and included in one or more other wireless communication protocols and systems.

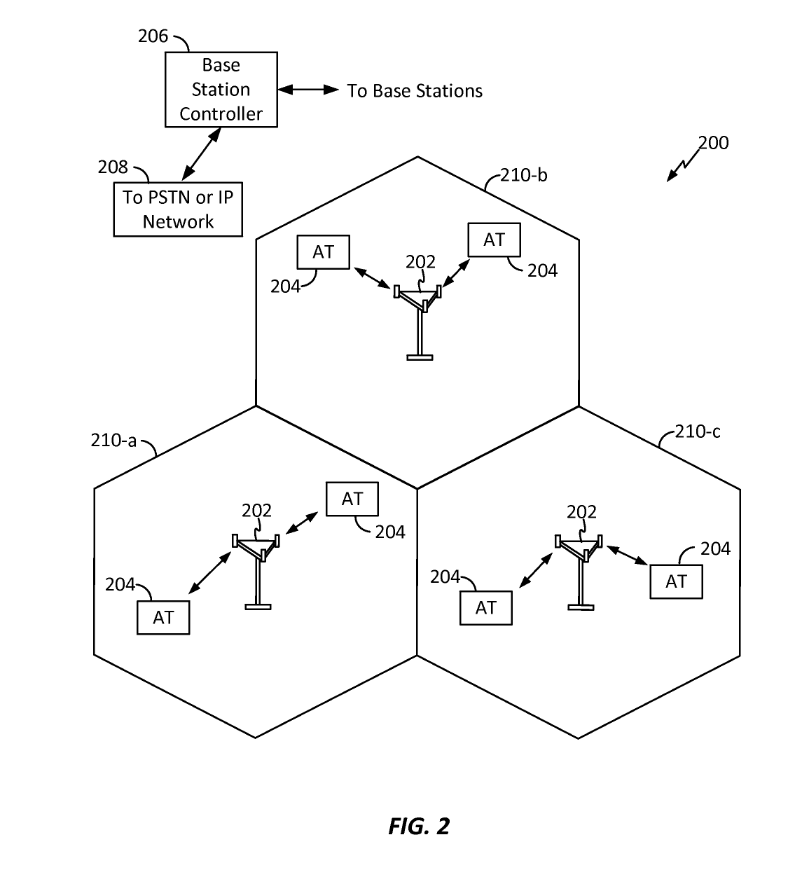

FIG. 2 is a schematic diagram illustrating an example of an access network in which one or more aspects of the present disclosure may find application. The wireless communication system 200 generally includes one or more base stations 202, one or more access terminals 204, one or more base station controllers (BSC) 206, and a core network 208 providing access to a public switched telephone network (PSTN) (e.g., via a mobile switching center/visitor location register (MSC/VLR)) and/or to an IP network (e.g., via a packet data switching node (PDSN)). In various examples, the processing system 114 illustrated in FIG. 1 may be included in any one or more of the base stations 202, the access terminals 204, and/or the base station controller 206. The system 200 may support operation on multiple carriers (waveform signals of different frequencies). Multi-carrier transmitters can transmit modulated signals simultaneously on the multiple carriers. Each modulated signal may be a CDMA signal, a TDMA signal, an OFDMA signal, a Single Carrier Frequency Division Multiple Access (SC-FDMA) signal, etc. Each modulated signal may be sent on a different carrier and may carry control information (e.g., pilot signals), overhead information, data, etc.

The base stations 202 may wirelessly communicate with the access terminals 204 via a base station antenna. The base stations 202 may each include a device that facilitates wireless connectivity (for one or more access terminals 204) to the wireless communications system 200. For example, the base stations 202 may include access points, base transceiver stations (BTS), radio base stations, radio transceivers, transceiver functions, basic service sets (BSS), extended service sets (ESS), Node Bs, femto cells, pico cells, and/or some other suitable device.

The base stations 202 are configured to communicate with the access terminals 204 under the control of the base station controller 206 via multiple carriers. Each of the base stations 202 can provide communication coverage for a respective geographic area. The coverage area 210 for each base station 202 here is identified as cells 210-a, 210-b, or 210-c. The coverage area 210 for a base station 202 may be divided into sectors (not shown, but making up only a portion of the coverage area). In a coverage area 210 that is divided into sectors, the multiple sectors within a coverage area 210 can be formed by groups of antennas with each antenna responsible for communication with one or more access terminals 204 in a portion of the cell.

The access terminals 204 may be dispersed throughout the coverage areas 210, and may wirelessly communicate with one or more sectors associated with each respective base station 202. The access terminal 204 may be adapted to employ a protocol stack architecture for communicating data between the access terminal 204 and one or more network nodes of the wireless communication system 200 (e.g., the base station 202). A protocol stack generally includes a conceptual model of the layered architecture for communication protocols in which layers are represented in order of their numeric designation, where transferred data is processed sequentially by each layer, in the order of their representation. Graphically, the “stack” is typically shown vertically, with the layer having the lowest numeric designation at the base.

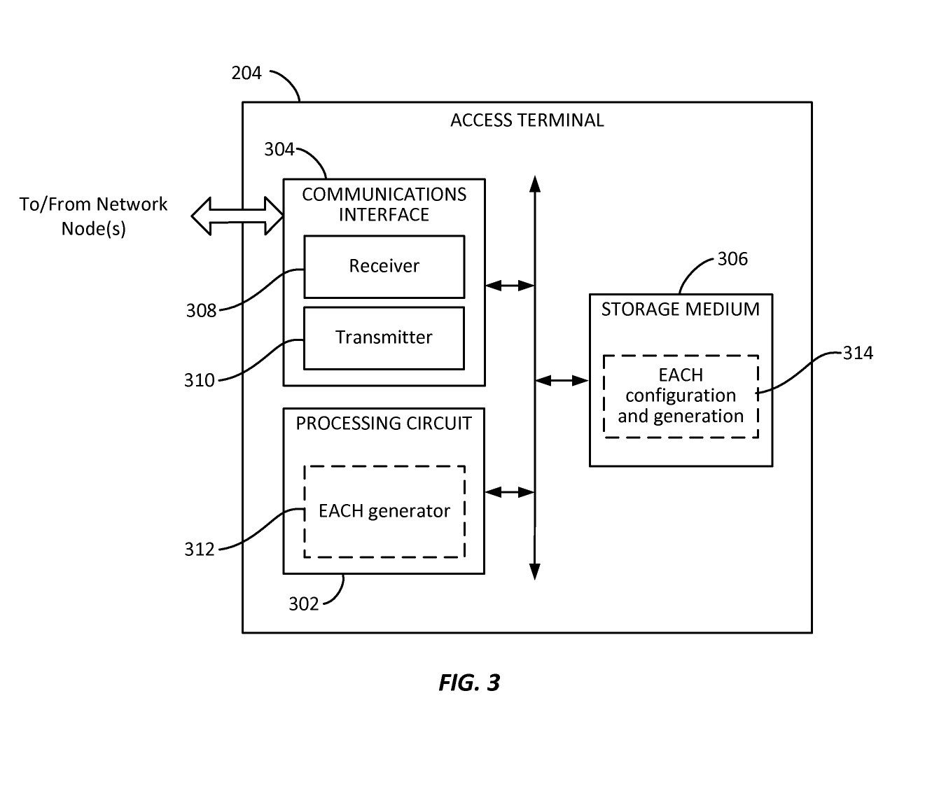

According to various aspects of the present disclosure, access terminals are provided, which are adapted to transmit a forward link including the enhanced access channel (EACH). Here, control information corresponding to the transmission of the EACH may be provided to the access terminals on the paging channel (PCH), as described in further detail below. FIG. 3 is a block diagram illustrating select components of an access terminal 204 adapted to employ such features according to at least one example. The access terminal 204 may include a processing circuit 302 coupled to a communications interface 304 and to a storage medium 306.

The processing circuit 302 may be adapted to obtain, process, and/or send data, control data access and storage, issue commands, and control other desired operations. In some examples, the processing circuit 302 may be the same or similar to the processing system 114 illustrated in FIG. 1. In some examples, the processing circuit 302 may include circuitry configured to implement desired programming provided by appropriate media in at least one embodiment. For example, the processing circuit 302 may be implemented as one or more of a processor, a controller, a plurality of processors and/or other structure configured to execute executable instructions including, for example, software and/or firmware instructions, and/or hardware circuitry. Examples of the processing circuit 302 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor but, in the alternative, the processor may be any conventional processor, controller, microcontroller, or state machine. A processor may also be implemented as a combination of computing components, such as a combination of a DSP and a microprocessor, a number of microprocessors, one or more microprocessors in conjunction with a DSP core, or any other such configuration. These examples of the processing circuit 302 are for illustration and other suitable configurations within the scope of the present disclosure are also contemplated.

The processing circuit 302 may be adapted for processing, including the execution of programming, which may be stored on the storage medium 306. In some instances, the processing circuit 302 may include an EACH generator 312. The EACH generator 312 may include circuitry and/or programming adapted to generate EACH transmissions in accordance with control information received, e.g., on the PCH.

The communications interface 304 may be configured to facilitate wireless communications of the access terminal 204. For example, the communications interface 304 may include circuitry and/or programming adapted to facilitate the communication of information bi-directionally with respect to one or more network nodes. The communications interface 304 may be coupled to one or more antennas (not shown), and includes wireless transceiver circuitry, including at least one receiver circuit 308 (e.g., one or more receiver chains) and/or at least one transmitter circuit 310 (e.g., one or more transmitter chains). By way of example and not limitation, the at least one transmitter circuit 310 may include circuitry, devices and/or programming adapted to provide various signal conditioning functions including amplification, filtering, and modulating transmission frames onto a carrier for uplink transmission over a wireless medium through an antenna.

The storage medium 306 may represent one or more devices for storing programming and/or data, such as processor executable code or instructions (e.g., software, firmware), electronic data, databases, or other digital information. The storage medium 306 may also be used for storing data that is manipulated by the processing circuit 302 when executing programming. The storage medium 306 may be any available media that can be accessed by a general purpose or special purpose processor. By way of example and not limitation, the storage medium 306 may include a non-transitory computer-readable medium such as a magnetic storage device (e.g., hard disk, floppy disk, magnetic strip), an optical storage medium (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and/or other non-transitory computer-readable mediums for storing information, as well as any combination thereof. The storage medium 306 may be coupled to, or at least accessible by the processing circuit 302 such that the processing circuit 302 can read information from, and write information to, the storage medium 306. In the examples, the storage medium 306 may be integral to the processing circuit 302.

Programming stored by the storage medium 306, when executed by the processing circuit 302, may cause the processing circuit 302 to perform one or more of the various functions and/or process steps described herein. The storage medium 306 may include EACH configuration and generation operations (i.e., instructions) 314. The EACH configuration and generation operations 314 may be implemented by the processing circuit 302 in, for example, the EACH generator 312. Thus, according to one or more aspects of the present disclosure, the processing circuit 302 may be adapted to perform any or all of the processes, functions, steps and/or routines for any or all of the access terminals (e.g., access terminal 204) described herein. As used herein, the term “adapted” in relation to the processing circuit 302 may refer to the processing circuit 302 being one or more of configured, employed, implemented, or programmed to perform a particular process, function, step and/or routine according to various features described herein.

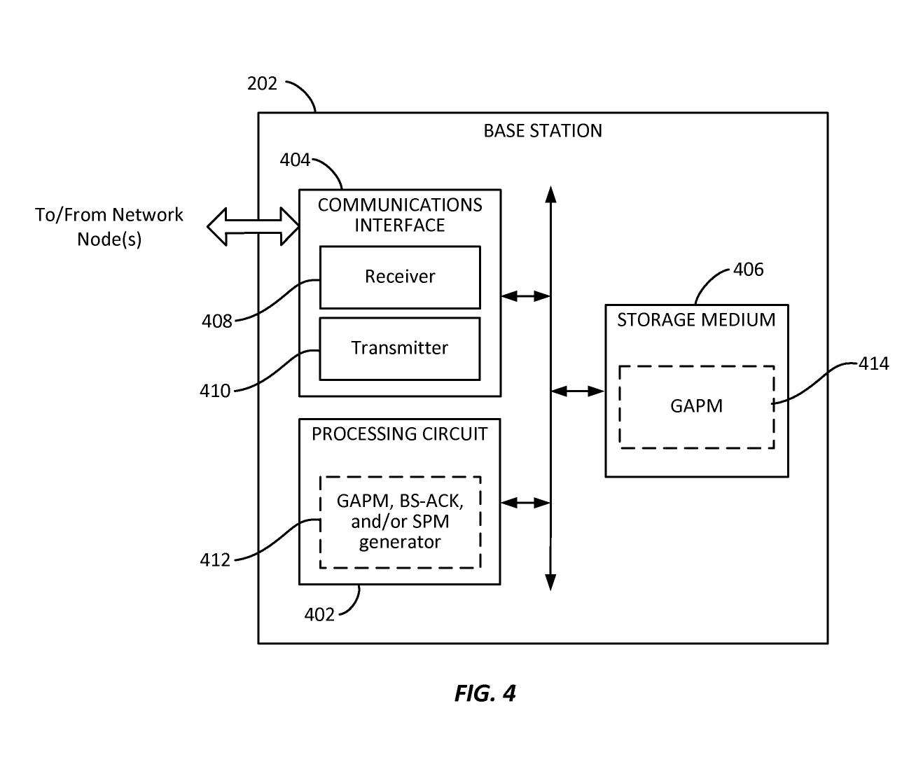

According to various further aspects of the present disclosure, base stations are provided, which are adapted to transmit on the PCH control information corresponding to the transmission of the EACH, as well as acknowledgments (e.g., a BS-ACK order) corresponding to received EACH transmissions. Turning to FIG. 4, a block diagram is shown illustrating select components of a base station 202 according to at least one implementation. The base station 202 may include a processing circuit 402 coupled to a communications interface 404 and to a storage medium 406.

The processing circuit 402 is arranged to obtain, process and/or send data, control data access and storage, issue commands, and control other desired operations. The processing circuit 402 may include circuitry configured to implement desired programming provided by appropriate media in at least one example, and may be implemented and/or adapted in a manner similar to the processing circuit 502 described above.

The communications interface 404 is configured to facilitate wireless communications of the base station 202. For example, the communications interface 404 may include circuitry and/or programming adapted to facilitate the communication of information bi-directionally with respect to one or more access terminals. The communications interface 404 may be coupled to one or more antennas (not shown), and includes wireless transceiver circuitry, including at least one receiver circuit 408 (e.g., one or more receiver chains) and/or at least one transmitter circuit 410 (e.g., one or more transmitter chains).

The storage medium 406 may represent one or more devices for storing programming and/or data, such as processor executable code or instructions (e.g., software, firmware), electronic data, databases, or other digital information. The storage medium 406 may be configured and/or implemented in a manner similar to the storage medium 306 described above.

Like the storage medium 306, the storage medium 406 includes programming stored thereon. The programming stored by the storage medium 406, when executed by the processing circuit 402, causes the processing circuit 402 to perform one or more of the various functions and/or process steps described herein. For example, the storage medium 406 may include a GAPM, BS-ACK, and/or SPM generator 412 adapted to cause the processing circuit 402 to configure and generate one or more of a GAPM message, a BS-ACK message, and/or an SPM on the PCH. Thus, according to one or more aspects of the present disclosure, the processing circuit 402 may be adapted to perform (in conjunction with the storage medium 406) any or all of the processes, functions, steps and/or routines for any or all of the network nodes described herein (e.g., base station 202 and/or base station controller 206 in FIG. 2). As used herein, the term “adapted” in relation to the processing circuit 402 may refer to the processing circuit 402 being one or more of configured, employed, implemented, and/or programmed to perform a particular process, function, step and/or routine according to various features described herein.

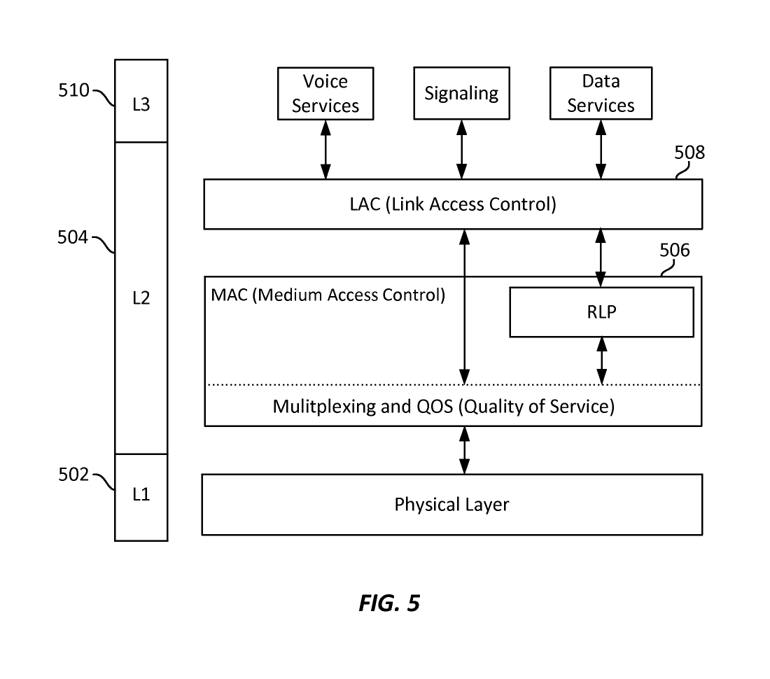

FIG. 5 is a schematic block diagram illustrating an example of a protocol stack architecture which may be implemented for communication between the base station 202 and the access terminal 204. Referring to FIGS. 2-4, the protocol stack architecture for the air interface between the base station 202 and the access terminal 204 is shown with three layers: Layer 1 (L1), Layer 2 (L2), and Layer 3 (L3).

Layer 1 502 is the lowest layer and implements various physical layer signal processing functions. Layer 1 502 is also referred to herein as the physical layer 502. This physical layer 502 provides for the transmission and reception of radio signals between the access terminal 204 and a base station 202.

The data link layer, called layer 2 (or “the L2 layer”) 504 is above the physical layer 502 and is responsible for delivery of signaling messages generated by Layer 3. The L2 layer 504 makes use of the services provided by the physical layer 502. The L2 layer 504 may include two sublayers: the Medium Access Control (MAC) sublayer 506, and the Link Access Control (LAC) sublayer 508.

The MAC sublayer 506 is the lower sublayer of the L2 layer 504. The MAC sublayer 506 implements the medium access protocol and is responsible for transport of higher layers' protocol data units using the services provided by the physical layer 502. The MAC sublayer 506 may manage the access of data from the higher layers to the shared air interface.

The LAC sublayer 508 is the upper sublayer of the L2 layer 504. The LAC sublayer 508 implements a data link protocol that provides for the correct transport and delivery of signaling messages generated at the layer 3. The LAC sublayer makes use of the services provided by the lower layers (e.g., layer 1 and the MAC sublayer).

Layer 3 510, which may also be referred to as the upper layer or the L3 layer, originates and terminates signaling messages according to the semantics and timing of the communication protocol between a base station 202 and the access terminal 204. The L3 layer 510 makes use of the services provided by the L2 layer. Information (both data and voice) message are also passed through the L3 layer 510.

In a conventional cdma2000 1x network, the paging channel (PCH) is utilized on the forward link to carry various overhead messages. These can include configuration messages and an Access Parameters message. These can also include paging data directed to a particular access terminal being paged. By utilizing the PCH, page messages can be transmitted from the network and broadcasted from a base station to access terminals within the cell. The PCH may be transmitted from a base station either in a continuous fashion or a slotted mode depending on a particular network's configuration.

Moreover, according to Rev 0 of cdma2000 1x standards, certain communication on the reverse link (uplink) transmitted from the access terminal to the base station utilizes the reverse access channel (RACH). In Rev A and later standards (e.g., Rev A-Rev E), an Enhanced Access Channel (EACH) may be provided in addition to or in the place of the RACH. In such systems, the EACH may be used to transmit, for example, short messages including signaling, MAC layer messages, paging responses, call origination messages, and data messages of a certain size. Of course, in accordance with an aspect of the present disclosure, any suitable signaling and/or data information may be carried on an EACH.

To utilize the EACH, a compatible system conventionally transmits control information (i.e., signaling) associated with the use of the EACH from a base station to the access terminal utilizing channels such as the primary broadcast control channel (P-BCCH) and/or the forward common control channel (F-CCCH). For example, an Enhanced Access Parameters Message (EAPM) may be transmitted to the access terminal on the P-BCCH including information such as an EAPM sequence number, persistence related parameters, access control parameters, power control information, interference correction information, etc., for use by the access terminal in preparing and transmitting EACH messages.

Further, after receiving EACH transmissions from the access terminal, the conventional base station generally acknowledges the EACH transmissions by transmitting an acknowledgment (e.g., a BS-ACK order) on a forward common control channel (F-CCCH).

For compatible systems, the use of the EACH provides various benefits as compared to the RACH, including being coherently demodulated, thus being more Eb/No efficient; having more flexible frame types and data rates; and being less subject to access collision than the RACH. However, the majority of currently deployed cdma2000 systems are configured to support Rev 0 standards, and thus lack the capability to utilize the EACH. Moreover, not all Rev A or later systems are configured to enable use of the EACH.

Many such Rev 0 systems, particularly those with machine-to-machine (M2M) devices, would benefit from the availability of the EACH for certain reverse link transmissions. However, upgrading a conventional Rev 0 system to a later revision capable of utilizing the EACH is generally very costly, and in general, also brings along other features in those later revisions that an operator may not want or need. Thus, such a system that is not capable of utilizing the EACH would benefit from the availability of the EACH without necessitating a full upgrade of the system.

Therefore, various aspects of the present disclosure provide a wireless communication system with the capability to utilize the EACH without necessitating a full system upgrade of the system, e.g., from Rev 0 to Rev A or later, or necessitating an upgrade of a Rev A or later system that is incapable of using the EACH, to a conventional Rev A or later system capable of utilizing the EACH, including unnecessary or unwanted features.

In accordance with some aspects of the disclosure, a System Parameters Message (SPM) may be transmitted from the base station 202 to the access terminal 204 utilizing the PCH. The SPM is an overhead message that generally includes information identifying the system transmitting that message, indicating whether an access terminal is roaming, etc. In an aspect of the present disclosure, the SPM may be adapted to include information (e.g., a predetermined bit) that indicates that control information associated with the transmission of the EACH will be transmitted on the PCH. In this way, the access terminal 204 may be notified that control information corresponding to the EACH transmission is to follow on a GAPM, as described in further detail below.

In a further aspect of the present disclosure, control information associated with the transmission of the EACH may be provided to the access terminal utilizing the paging channel (PCH). For example, a generic access parameters message (GAPM) may be broadcasted from the base station to the access terminal utilizing the PCH, rather than the conventional utilization of the extended access parameters message (EAPM). In this way, by monitoring the PCH, and without needing to monitor a P-BCCH, the access terminal 204 may receive information about how to operate and utilize the EACH.

In accordance with aspects of the present disclosure, the GAPM carried on the PCH may carry a suitable combination of the following fields. The GAPM may include extended system parameters including USE_TMSI, PREF_MSID_TYPE and PILOT_REPORT. Further, the GAPM may include parameters such as ACC_ENT_HO_ORDER; ACCESS_HO; ACCESS_HO_MSG_RSP; ACCESS_PROBE_HO; ACC_HO_LIST_UPD; ACC_PROBE_HO-OTHER_MSG; and MAX_NUM_PROBE_HO. For these parameters, a Boolean may be added to the GAPM, thus, enabling skipping of these fields if the same values are applicable for the ACH and the EACH. Further, the GAPM may include a parameter NUM_FCCCH, which may be set to a value of a PAGE_CHAN parameter received on the SPM, described above.

In some aspects of the disclosure, a Boolean may be included in the GAPM for access control based on the call type parameters (e.g., ACCT). Here, in one example, a value of 0 may indicate either that the EACH feature described in the present disclosure is not supported, or to utilize values received on the access parameters message (APM).

Further, in some aspects of the disclosure, the utilization of the EACH as paired with the GAPM may be untied to any reception of the ANS_41, MC-RR, etc. on the P-BCCH; to the receiving of a unicast page on the F-CCCH; or to the receiving of a broadcast page on the F-CCCH. Moreover, in some examples, the parameter RLGAIN_ADJ transmitted in the ECAM may be based on the transmit power of the EACH.

In a further aspect of the present disclosure, to acknowledge the EACH transmission received from the access terminal 204, the base station 202 may transmit an acknowledgment message, e.g., a BS-ACK order, on the PCH. In one example, the transmission of the BS-ACK order on the PCH may be enabled if a value of a MODE_ID parameter in a header of an R-EACH transmission is set to 1.

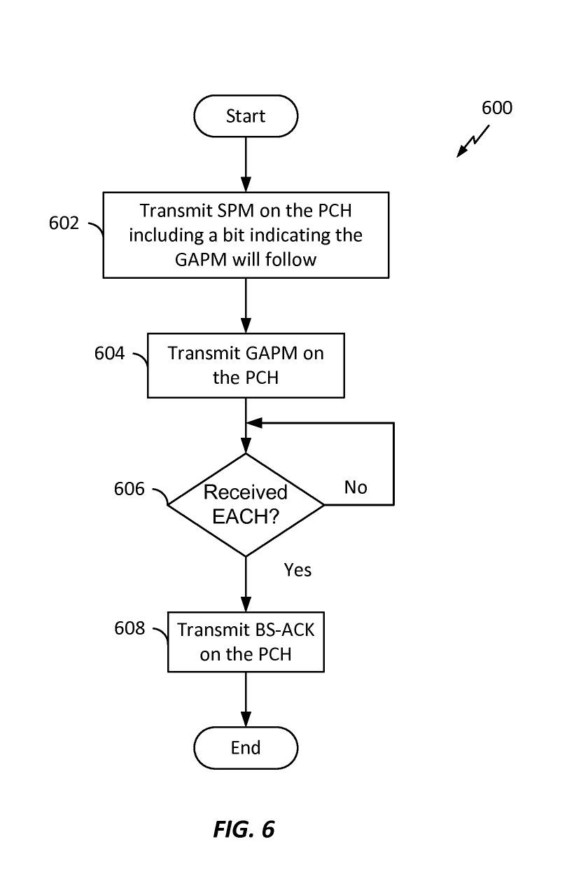

FIG. 6 is a flow chart illustrating a process 600 of wireless communication operable at a base station. In some examples, the process 600 may be operable at the base station 202 configured for operation in a cdma2000 1x network.

At step 602, the base station 202 may transmit the SPM on the PCH, configured to indicate that the GAPM will follow. For example, a particular bit on the SPM may be adapted to take a value indicating whether the GAPM will be carried on the PCH. By utilizing this signaling, the access terminal 204 receiving the PCH that includes the SPM may be notified that the control information associated with the use of the EACH (e.g., the GAPM) will follow on the PCH.

At step 604, the base station 202 may transmit the GAPM to the access terminal 204 on the PCH. Here, the GAPM may be adapted to include control information associated with an EACH transmission. In some examples, this control information may be the same as or similar to the information that might be carried on the Extended Access Parameters Message (EAPM) message in a conventional network. For example, the GAPM may carry information such as an GAPM sequence number, persistence related parameters, access control parameters, power control information, interference correction information, etc., for use by the access terminal in preparing and transmitting EACH messages, and/or any other suitable control information corresponding to the EACH transmission.

Based on the GAPM transmitted at step 604, the base station 202 may expect to receive an EACH transmission from the access terminal 204. Thus, at step 606, the base station 202 may determine whether an EACH transmission was received from the access terminal 204. If not, then the process may return to step 606 and await reception of the EACH. On the other hand, if a transmission on the EACH is received, then at step 608, after decoding and suitably processing the received message, the base station 202 may transmit an acknowledgment (e.g., a BS-ACK order) to respond to the access terminal 204 that transmitted the EACH transmission, utilizing the PCH to carry the acknowledgment.

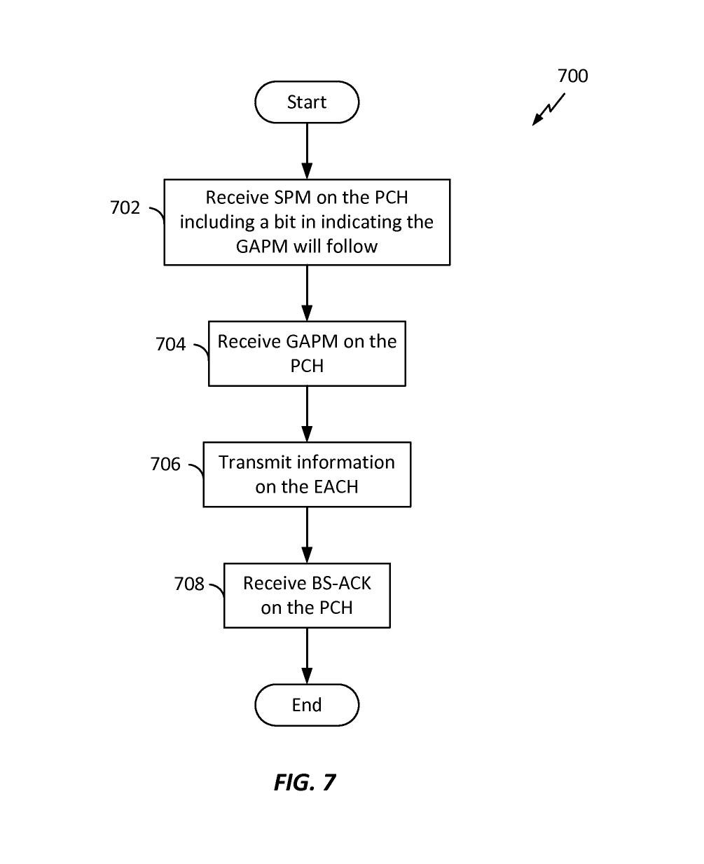

Moving on to FIG. 7, a flow chart is provided to illustrate a corresponding process 700 of wireless communication operable at an access terminal. In some examples, the process 700 may be operable at the access terminal 204 configured for operation in a cdma2000 1x network.

At step 702, the access terminal 204 may receive a SPM on the PCH, configured to indicate that the GAPM will follow. As described above, in one example, a particular bit on the SPM may be adapted to take a value indicating whether the GAPM will be carried on the PCH. By utilizing this signaling, the access terminal 204 receiving the PCH may be notified that the control information associated with the use of the EACH will follow on the PCH.

At step 704, the access terminal 204 may receive the GAPM on the PCH. Here, as described above, the GAPM may be adapted to include control information corresponding to an EACH transmission, such as the information that might be carried on the Extended Access Parameters Message (EAPM) message in a conventional network. For example, the GAPM may carry timing information, modulation, encoding, power levels, and/or any other suitable information corresponding to the EACH transmission.

At step 706, the access terminal 204 may transmit information on the EACH. Here, the access terminal 204 may utilize the control information contained on the GAPM received on the PCH at step 704 to configure the transmission on the EACH. At step 708, in response to the EACH transmission of step 706, the access terminal 204 may receive an acknowledgement message (e.g., a BS-ACK order) transmitted from the base station 202 on the PCH.

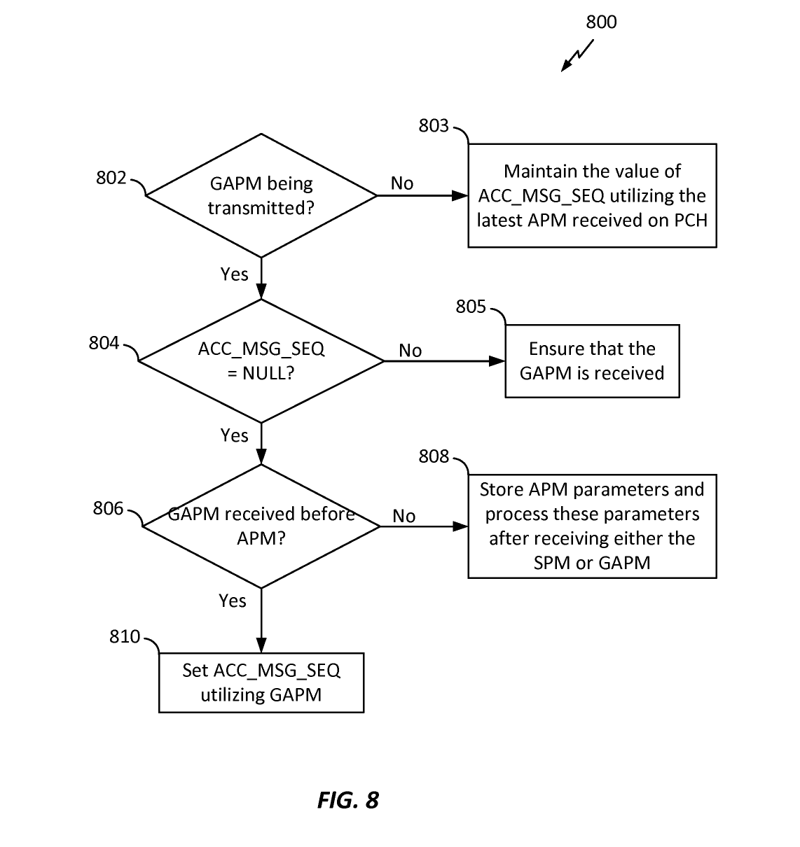

FIG. 8 is a flow chart illustrating a process 800 of wireless communication operable at an access terminal 204. The illustrated exemplary process provides internal management of the access terminal 204 to support transmission of the EACH based on the control information received in the GAPM. That is, a conventional access terminal typically maintains a sequence number ACC_MSG_SEQ utilizing either the most recent access parameters message (APM) received on the PCH, or utilizing the enhanced access parameters message (EAPM) received on the BCCH. However, in an aspect of the present disclosure, at step 802, the access terminal 204 may determine if the GAPM is being transmitted. If not, then at step 803, the access terminal 204 may behave the same as a conventional access terminal, e.g., maintaining the value of ACC_MSG_SEQ utilizing the latest APM received on the paging channel. If yes, however, then the process may proceed to step 804, wherein the access terminal 204 may determine if the parameter ACC_MSG_SEQ is set to NULL. If not, then the process may proceed to step 805, wherein access terminal 204 may ensure that the GAPM is received. If yes, however, then the process may proceed to step 806, wherein the access terminal 204 may determine whether the GAPM was received before the APM. If yes, then at step 810 the access terminal 204 may set the value of ACC_MSG_SEQ utilizing the GAPM received on the PCH, and may wait for the APM based on GAPM contents. On the other hand, if at step 806 the access terminal 204 determines that the APM was received before the GAPM, then at step 808 the access terminal 204 may store the received APM parameters, and process these parameters after receiving either the SPM or GAPM.

Several aspects of a telecommunications system have been presented with reference to a cdma2000 1x system. As those skilled in the art will readily appreciate, various aspects described throughout this disclosure may be extended to other telecommunication systems, network architectures and communication standards.

By way of example, various aspects may be extended to systems employing Universal Mobile Telecommunications Systems (UMTS), Long Term Evolution (LTE) (in FDD, TDD, or both modes), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. The claims are not intended to be limited to the aspects shown herein, but are to be accorded the full scope consistent with the language of the claims. Reference to an element in the singular is not intended to mean “one and only one” unless specifically so stated, but rather “one or more.” Unless specifically stated otherwise, “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

We claim:

1. A method of wireless communication operable at an access terminal, comprising:
receiving, on a paging channel, control signaling associated with the transmission of an enhanced access channel (EACH); and
transmitting the EACH in accordance with the control signaling received on the paging channel.

2. The method of claim 1, wherein the paging channel further carries paging information for paging one or more access terminals.

3. The method of claim 1, wherein the control signaling comprises a generic access parameters message (GAPM) comprising one or more parameters for use by the access terminal in configuring the EACH transmission.

4. The method of claim 1, further comprising:
receiving, prior to the receiving of the control signaling, a system parameters message (SPM) on the paging channel, the SPM comprising information indicating that the control signaling related to the EACH will follow on the paging channel.

5. The method of claim 4, wherein the information indicating that the control signaling related to the EACH will follow on the paging channel comprises a predetermined bit adapted to indicate whether the control signaling related to the EACH will follow on the paging channel.

6. The method of claim 1, further comprising:
receiving, on the paging channel, an acknowledgment message responsive to the transmission of the EACH.

7. The method of claim 6, wherein the acknowledgment message comprises a BS-ACK order.

8. The method of claim 1, wherein the access terminal is configured according to a 3GPP2 1x rev0 specification.

9. The method of claim 1, wherein the access terminal is configured according to a 3GPP2 1x revA, revB, revC, revD, or revE specification.

10. A method of wireless communication operable at an access terminal, comprising:
receiving, on a forward link channel, control signaling associated with the transmission of an enhanced access channel (EACH); and
transmitting the EACH in accordance with the control signaling received on the forward link channel,
wherein the access terminal is configured according to a 3GPP2 1x rev0 specification.

11. The method of claim 10, wherein the forward link channel is a paging channel.

12. An access terminal configured for wireless communication, comprising:
means for receiving, on a paging channel, control signaling associated with the transmission of an enhanced access channel (EACH); and
means for transmitting the EACH in accordance with the control signaling received on the paging channel.

13. The access terminal of claim 12, wherein the paging channel further carries paging information for paging one or more access terminals.

14. The access terminal of claim 12, wherein the control signaling comprises a generic access parameters message (GAPM) comprising one or more parameters for use by the access terminal in configuring the EACH transmission.

15. The access terminal of claim 12, further comprising:
means for receiving, prior to receiving the control signaling, a system parameters message (SPM) on the paging channel, the SPM comprising information indicating that the control signaling related to the EACH will follow on the paging channel.

16. The access terminal of claim 15, wherein the information indicating that the control signaling related to the EACH will follow on the paging channel comprises a predetermined bit adapted to indicate whether the control signaling related to the EACH will follow on the paging channel.

17. The access terminal of claim 12, further comprising:
means for receiving, on the paging channel, an acknowledgment message responsive to the transmission of the EACH.

18. The access terminal of claim 17, wherein the acknowledgment message comprises a BS-ACK order.

19. The access terminal of claim 12, wherein the access terminal is configured according to a 3GPP2 1x rev0 specification.

20. The access terminal of claim 12, wherein the access terminal is configured according to a 3GPP2 1x revA, revB, revC, revD, or revE specification.

21. An access terminal configured for wireless communication, comprising:
means for receiving, on a forward link channel, control signaling associated with the transmission of an enhanced access channel (EACH); and
means for transmitting the EACH in accordance with the control signaling received on the forward link channel,
wherein the access terminal is configured according to a 3GPP2 1x rev0 specification.

22. The access terminal of claim 21, wherein the forward link channel is a paging channel.

23. An access terminal configured for wireless communication, comprising:
a processing circuit;
a communication interface coupled to the processing circuit; and
a memory coupled to the processing circuit,
wherein the processing circuit is configured to:
receive, on a paging channel, control signaling associated with the transmission of an enhanced access channel (EACH); and
transmit the EACH in accordance with the control signaling received on the paging channel.

24. The access terminal of claim 23, wherein the paging channel further carries paging information for paging one or more access terminals.

25. The access terminal of claim 23, wherein the control signaling comprises a generic access parameters message (GAPM) comprising one or more parameters for use by the access terminal in configuring the EACH transmission.

26. The access terminal of claim 23, further comprising:
receiving, prior to the receiving of the control signaling, a system parameters message (SPM) on the paging channel, the SPM comprising information indicating that the control signaling related to the EACH will follow on the paging channel.

27. The access terminal of claim 26, wherein the information indicating that the control signaling related to the EACH will follow on the paging channel comprises a predetermined bit adapted to indicate whether the control signaling related to the EACH will follow on the paging channel.

28. The access terminal of claim 23, further comprising:
receiving, on the paging channel, an acknowledgment message responsive to the transmission of the EACH.

29. The access terminal of claim 28, wherein the acknowledgment message comprises a BS-ACK order.

30. The access terminal of claim 23, wherein the access terminal is configured according to a 3GPP2 1x rev0 specification.

31. The access terminal of claim 23, wherein the access terminal is configured according to a 3GPP2 1x revA, revB, revC, revD, or revE specification.

32. An access terminal configured for wireless communication, comprising:
a processing circuit;
a communication interface coupled to the processing circuit; and
a memory coupled to the processing circuit,
wherein the processing circuit is configured to:
receive, on a forward link channel, control signaling associated with the transmission of an enhanced access channel (EACH); and
transmit the EACH in accordance with the control signaling received on the forward link channel,
wherein the access terminal is configured according to a 3GPP2 1x rev0 specification.

33. The access terminal of claim 32, wherein the forward link channel is a paging channel.

34. A computer program product, comprising:
a computer-readable storage medium operable at an access terminal, comprising:
instructions for causing a computer to receive, on a paging channel, control signaling associated with the transmission of an enhanced access channel (EACH); and
instructions for causing a computer to transmit the EACH in accordance with the control signaling received on the paging channel.

35. The computer program product of claim 34, wherein the paging channel further carries paging information for paging one or more access terminals.

36. The computer program product of claim 34, wherein the control signaling comprises a generic access parameters message (GAPM) comprising one or more parameters for use by the access terminal in configuring the EACH transmission.

37. The computer program product of claim 34, wherein the computer-readable storage medium further comprises:
instructions for causing a computer to receive, prior to receiving the control signaling, a system parameters message (SPM) on the paging channel, the SPM comprising information indicating that the control signaling related to the EACH will follow on the paging channel.

38. The computer program product of claim 37, wherein the information indicating that the control signaling related to the EACH will follow on the paging channel comprises a predetermined bit adapted to indicate whether the control signaling related to the EACH will follow on the paging channel.

39. The computer program product of claim 34, wherein the computer-readable storage medium further comprises:
instructions for causing a computer to receive, on the paging channel, an acknowledgment message responsive to the transmission of the EACH.

40. The computer program product of claim 39, wherein the acknowledgment message comprises a BS-ACK order.

41. The computer program product of claim 34, wherein the access terminal is configured according to a 3GPP2 1x rev0 specification.

42. The computer program product of claim 34, wherein the access terminal is configured according to a 3GPP2 1x revA, revB, revC, revD, or revE specification.

43. A computer program product, comprising:
a computer-readable storage medium operable at an access terminal, comprising:
instructions for causing a computer to receive, on a forward link channel, control signaling associated with the transmission of an enhanced access channel (EACH); and
instructions for causing a computer to transmit the EACH in accordance with the control signaling received on the forward link channel,
wherein the access terminal is configured according to a 3GPP2 1x rev0 specification.

44. The computer program product of claim 43, wherein the forward link channel is a paging channel.
